(19) United States
(12) Patent Application Publication
(10) Pub. No.: US 2018/0330699 A1
(43) Pub. Date: Nov. 15, 2018

(54) CHINREST DEVICE AND SYSTEMS AND METHODS OF USE THEREOF

(71) Applicant: Evan Buttemer, San Francisco, CA (US)

(72) Inventor: Evan Buttemer, San Francisco, CA (US)

(21) Appl. No.: 15/979,109

(22) Filed: May 14, 2018

Related U.S. Application Data
(60) Provisional application No. 62/506,399, filed on May 15, 2017.

(51) Int. Cl. G10D 3/18; G06F 3/0483; G10H 1/34

(52) U.S. Cl. CPC G10D 3/18; G06F 3/0483; G10H 2220/461; G10H 2220/015; G10H 1/348

(57) ABSTRACT

The present disclosure relates to a chinrest device for changing a display on a display device. The chinrest device may be removably attached to a stand or musical instrument and may be associated with a display device. Also described herein are methods of using a chinrest device or system to change a display (e.g., to turn the page of a book or musical score) on a display device.

### FIELD

The present disclosure relates generally to chinrest devices for changing a display on a display device. The chinrest device may be removably attached to a stand or musical instrument and may be associated with a display device. Also described herein are methods of using a chinrest device or system to change a display (e.g., to turn the page of a book or musical score) on a display device.

### BACKGROUND

Turning the page of a book or musical score is inherently difficult when a user does not have or is unable to use arms and/or hands. For example, turning pages of a musical score during an instrumental performance is problematic. It is not always practical to arrange the pages such that the turn can be accomplished when the performer's hands are not fully occupied with the instrument. Many mechanical devices have been developed to allow for hands-free page turning using traditional paper scores; however, such devices are cumbersome and unreliable and have never been widely used.

Performers are increasingly choosing to read musical notation from electronically displayed musical scores instead of traditional ink-and-paper scores. One of the advantages of electronic musical scores is that hands-free page turning can be accomplished more easily. Foot pedals may be used to facilitate turning the page of an electronic score. However, while foot pedals are less cumbersome than the mechanical devices mentioned in the previous paragraph, there is a need for improved devices for electronically turning pages.

### SUMMARY

According to various embodiments, described herein is a chinrest device having a contacting surface comprising a contour for receiving at least one of a neck, jaw, chin or head; at least one control mechanism; at least one sensor in communication with the at least one control mechanism; and a transceiver in communication with the at least one sensor. The device may further include an attachment mechanism, for example, that is adapted to attach the chinrest device to a violin, a viola or a chinrest device stand. The chinrest device is portable and can be removably attached to a structure such as a musical instrument or stand. The control mechanism may include an adjustment device for adjusting the position of the control mechanism on the contacting surface. In certain embodiments, the chin rest device may include an indicator light and/or a processor, wherein the processor is in communication with the at least one sensor and the indicator light. The chinrest device may include battery to power at least one of the transceiver and the at least one sensor. The contacting surface may include a material selected from a group consisting of leather, plastic, nylon composite, polylactic acid, acrylonitrile butadiene styrene, plastic composite, ceramic, fiberglass, epoxy, metal, carbon-fiber, fiber-glass, wood, foam, cotton and combinations thereof. In certain embodiments, the control mechanism may be a button, a touch sensitive sensor, a vertical lever, a light sensitive sensor, a rotating knob, a multi-directional joystick, a pivot, a level sensor, an accelerometer, a heat-sensitive sensor, a load cell sensor, a spring and combinations thereof. The transceiver of the chinrest device may be a wireless communications device selected from a Wi-Fi device, Bluetooth device, WLAN device, WPAN device and 4G device.

Also described herein are systems for controlling a display of at least one display device. A system may have a chinrest device; and at least one display device comprised of a memory; a wireless transceiver; a display; and a processor operatively coupled to the memory, the wireless transceiver and the display. The processor may be configured to receive a chinrest device output signal from a chinrest device via the wireless transceiver; determine a display action based on the chinrest device output signal; access data on which the display action is to be performed from the memory; and perform the display action on the data. The display action may include a forward page turn or a backwards page turn. The chinrest device in the system may include a control mechanism, wherein different control signals are transmitted depending on the manner of actuation of the control mechanism.

Also described herein are computer-implemented methods of changing a display on a display device using a chinrest device. Such methods can include receiving by a sensor of a chinrest device, an input signal from a control mechanism of the chinrest device; generating a chinrest device output signal by the chinrest device sensor; transmitting, by the chinrest device, the chinrest device output signal to a display device, wherein a processor of the display device determines a display action based on the chinrest device output signal and accesses data on which the display action is to be performed from a memory of the display device; and performing a display action by the display device, wherein performing the display action comprises displaying at least a portion of the data on a user interface of the display device. The display device may be selected from a tablet computer, a laptop computer, a desktop computer, an e-book reader, a television, a wireless projector, a smartphone and a monitor. The control mechanism may be selected from a button, a touch sensitive sensor, a vertical lever, a light sensitive sensor, a rotating knob, a multi-directional joystick, a pivot, a level sensor, an accelerometer, a heat-sensitive sensor, a load cell sensor, a spring and combinations thereof. The input signal from the control mechanism can result from actuation of the control mechanism, wherein actuation of the control mechanism may include moving the control mechanism from a first position to a second position. In some embodiments, actuation of the control mechanism includes pivoting the control mechanism in a lateral motion or moving the control mechanism in a vertical motion. The display may be a digital musical score, a digital book, a text file, a spreadsheet, a digital presentation, a webpage and series of computer screens. The data may include a musical score, wherein performing the display action includes changing a page of the musical score. The input signal from the control mechanism can results from actuation of a button, a touch sensitive sensor, a vertical lever, a light sensitive sensor, a rotating knob, a multi-directional joystick, a pivot, a level sensor, an accelerometer, a heat-sensitive sensor, a load cell sensor and combinations thereof. The data can be selected from a chinrest device driver application, a chinrest device image viewer application and a digital musical score file. In certain embodiments, the chinrest device may be attached to a violin, a viola or a chinrest device stand.

### BRIEF DESCRIPTION OF THE DRAWINGS

FIG. 1 shows a chinrest device in accordance with embodiments described herein, wherein the chinrest device is attached to a violin.

FIG. 2 shows an embodiment of a chinrest device, which includes a button as a control mechanism.

FIG. 3a shows an embodiment of a chinrest device, which includes two control mechanisms: a lever that forms part of the contact surface, and a touch sensitive sensor.

FIG. 3b shows an embodiment of a chinrest device, which includes two control mechanisms: a lever that forms part of the contact surface, and a touch sensitive sensor.

FIG. 4 shows an embodiment of a chinrest device in which the entire contact surface pivots and serves as a control mechanism.

FIG. 5 shows an embodiment of a chinrest device in which a vertical lever, with a positional adjustability feature, is used as a control mechanism.

FIG. 6 shows a violin performer using a chinrest device in accordance with embodiments herein to change the display of musical notation.

FIG. 7 shows a block diagram of a chinrest device system according to embodiments described herein.

FIG. 8 shows a block diagram of a computer system for use with the chinrest device system as shown and described in embodiments herein.

FIG. 9 shows an embodiment of a chinrest device stand in accordance with embodiments described herein.

### DETAILED DESCRIPTION

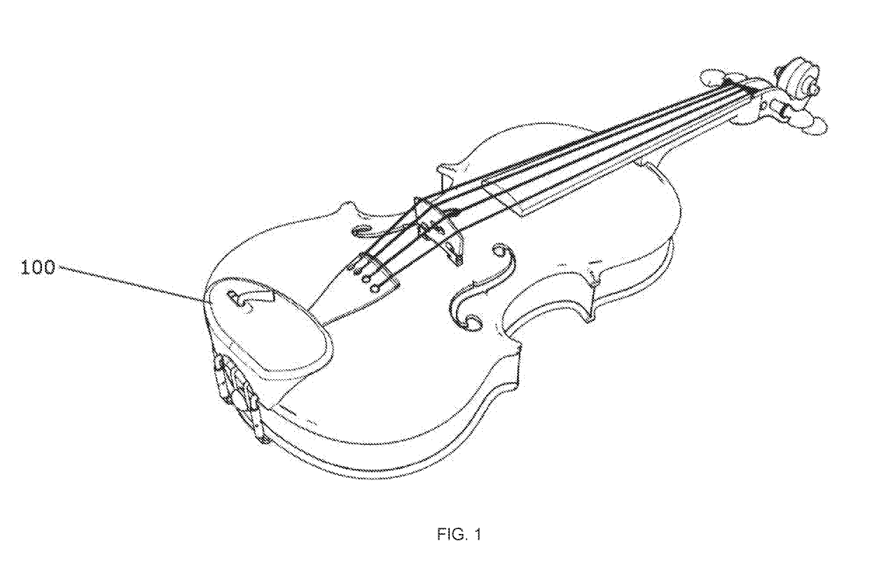

Disclosed herein are chinrest devices for changing an electronic display on a display device. For example, the chinrest device may be removably attached to a stand (e.g., on which to rest one's head) or a musical instrument such as a violin, viola, or other similar instrument. Also described are systems wherein at least one chinrest device is associated with (e.g., wired or wirelessly connected to) at least one display device. Methods for using such chinrest devices and systems are also described. Such methods include effecting changes in the display (e.g., turning the page of a musical notation or a book, or swiping between computer screens) on an electronic display device. In one embodiment, during use, a violin or a viola is held between a user's shoulder and head (e.g., the jaw, cheek, chin, neck, etc.), and a chinrest device may be removably attached to the top of the instrument in order to provide a comfortable and suitably positioned surface with which the user's head can make contact. The contacting surface of the chinrest device may have a traditional shape and configuration (e.g., as shown in FIG. 1); however, other styles of contacting surface may also be employed. The contacting surface of the chinrest device may be contoured so that the head is not fixed in one position, but has a certain range through which it can pivot while still providing the force necessary to hold the instrument securely. This gives the performer's head a parameter of freedom during performance, and therefore, transforming a chinrest into a chinrest device as described herein for changing an electronic display on a display device provides a natural mechanism for performers (or those without the use of arms and/or hands) to accomplish hands-free page turning.

The chinrest devices and related systems and methods of use disclosed herein improve hands-free page turning with the following advantages: 1) the chinrest devices are hidden from view, and therefore, do not pose a visual distraction to the audience; 2) a performer's use of head motions to change a visual display is an intuitive process, whereas the use of, for example, a foot is not similarly intuitive and requires the involvement and coordination of additional body parts; 3) the chinrest devices described herein are less prone to user error than, for example, foot pedals, because the page turning mechanism is located in or near the performer's normal field of view, and because the location of the page turning mechanism relative to the performer's body does not change; 4) the chinrest devices allow a performer to easily perform while standing; 5) the devices allow the performer to move about while performing, for example, to cue other musicians, to make musically expressive body movements, to adjust for space constraints, or to improve sight lines to a conductor, other performers, or the musical score; 6) users have the flexibility to adjust the position of the control mechanism(s) on the chinrest device(s) enhancing ease of use and comfort of the devices; 7) violin and viola players encounter difficulties due to the number of items they are required to carry on- and off-stage before and after performance (e.g., instrument, bow, music display, and additional accessories)—the chinrest devices and systems described herein are more convenient, for example, as compared to foot pedals, because they do not require transport of a bulky extra device; and 8) the chinrest devices allow for operation using tactile senses, for example, by a touch-sensitive area (e.g., jaw, chin, neck, cheek, etc.) to effect actuation of the control mechanism.

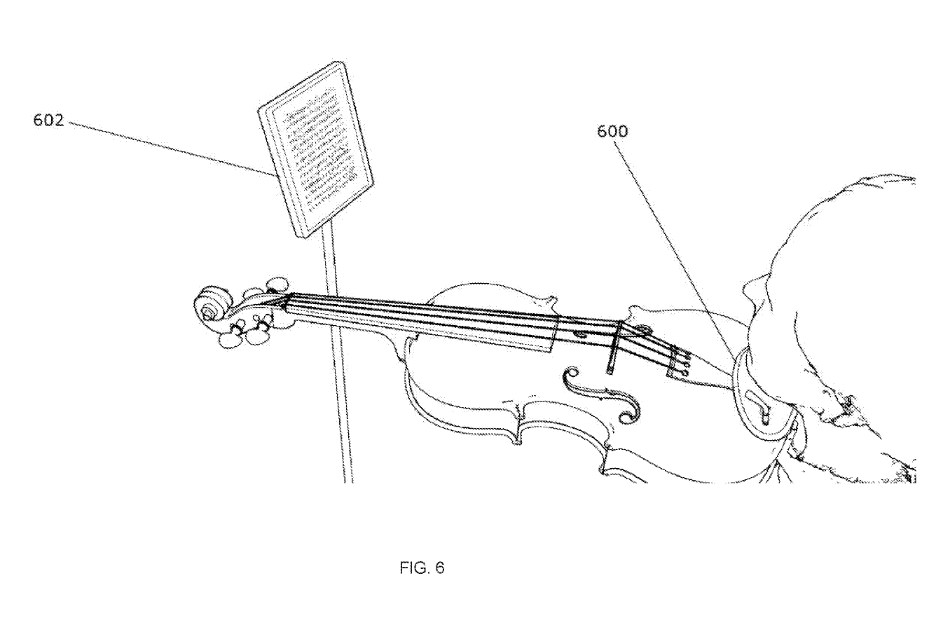

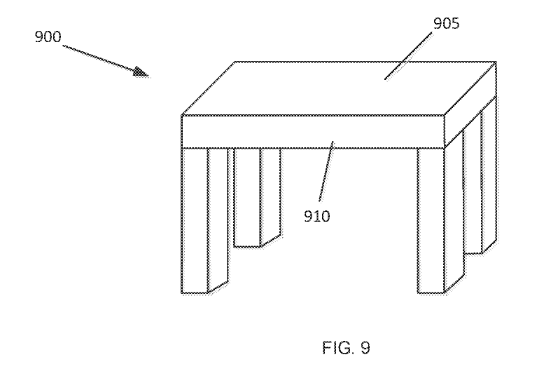

As shown in FIG. 1, an embodiment of a device according to the present disclosure may be in the form of a chinrest 100 that can be removably attached to, for example, a stand (i.e., to hold a user's head) as shown in FIG. 9 or a violin, viola, or similar instrument. When a chinrest device stand is used, the chinrest device may be attached to a ledge 910 of a plate 905 of a chinrest device stand 900. As shown in FIG. 6, the chinrest device 100 can be associated with a display device to effect changes in an electronic display (e.g., turning the page of a musical notation, turning the page of a book, etc.) presented on the display device 602. According to at least one embodiment, a chinrest device as disclosed herein has at least one control mechanism, which can be actuated by a user's head. As will be described in more detail below, when the control mechanism is actuated, an output signal may be sent to a display device using a wired or wireless connection, for example, using a Bluetooth wireless protocol, Wi-Fi, or any other suitable method of wireless communication between electronic devices. When the control signal is received by the display device, the display device changes the display, for example, by turning the page of a document (e.g., a musical score, a book, computer screens, etc.), or any other change in the display, which could be considered useful to the user.

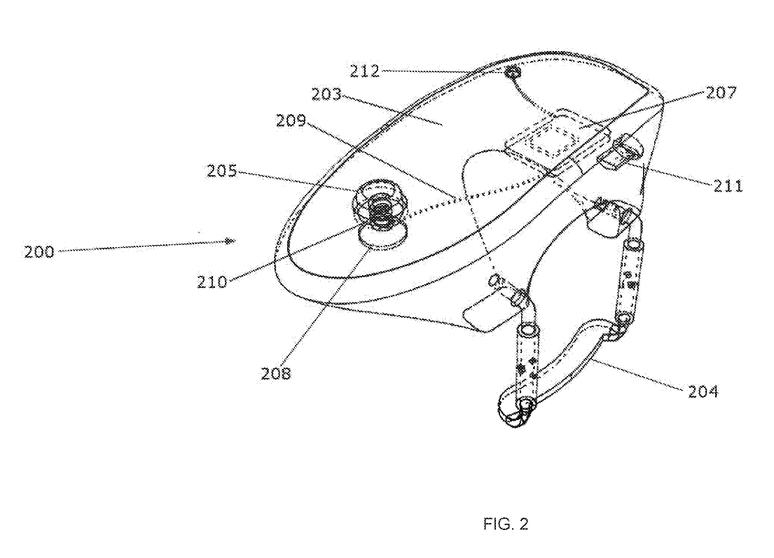

As shown in FIGS. 2-5, the chinrest device 200, 300, 400, 500 includes a contacting surface 203, 303, 403, 503 that makes physical contact with a user's head (e.g., chin, cheek, jaw, neck, etc.) during use. The contacting surface 203, 303, 403, 503 may be shaped in any way that facilitates the preferences of the user or the stability of the stand or instrument. In some embodiments, the shape of the contacting surface is contoured for comfortably receiving the user's head and to enable the user to grip and/or move the chinrest device and/or control mechanism(s). Similarly, the contacting surface 203, 303, 403, 503 can be positioned, relative to the stand or instrument, in any way that facilitates the preferences of the performer or the stability of the stand or instrument during use. The material of the contacting surface 203, 303, 403, 503 may be selected from leather, plastic, nylon composite, polylactic acid, acrylonitrile butadiene styrene, plastic composite, ceramic, fiberglass, epoxy, metal, carbon-fiber, fiber-glass, wood, foam, cotton and combinations thereof.

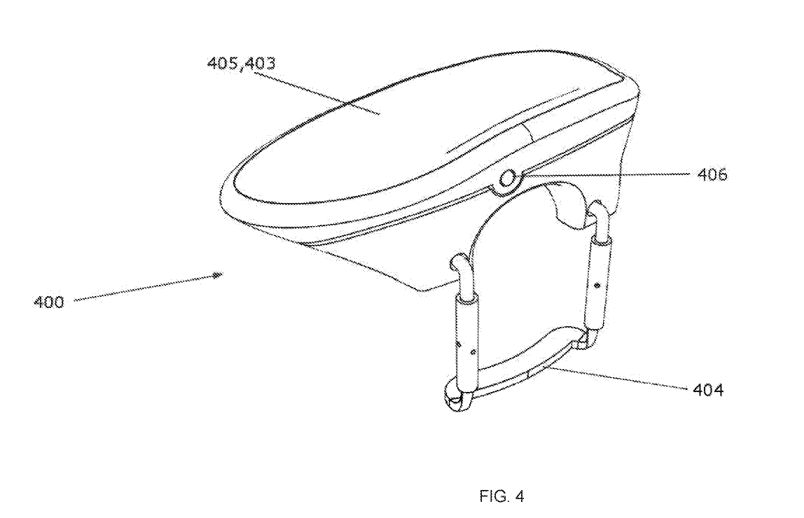

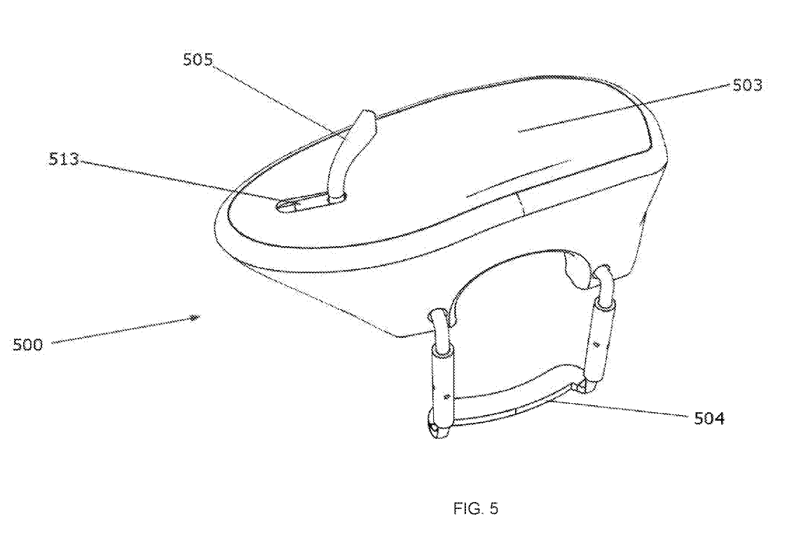

As further described in FIGS. 2-5, the chinrest device 200, 300, 400, 500 includes at least one control mechanism 205, 305, 306, 405, 406, 505 that can be actuated by the user's head. In some embodiments, it may be possible for a user to use another body part, for example, an elbow (e.g., for use by a person without hands) or a finger (e.g., during a performance when a user's hands are not occupied) in order to actuate the control mechanism 205, 305, 306, 405, 406, 505. The control mechanism 205, 305, 306, 405, 406, 505 can be any mechanism suitable for actuation by the user as described. In some embodiments, the control mechanism 205, 305, 306, 405, 406, 505 has movable elements that operate together with functional components. The movable element (such as those described above as the control mechanism) may be any suitable device that can be actuated by a user to send an input signal to a functional component, such as sensor 208, 308 (not shown in FIGS. 4 and 5), of the chinrest device 100, 200, 300, 400, 500.

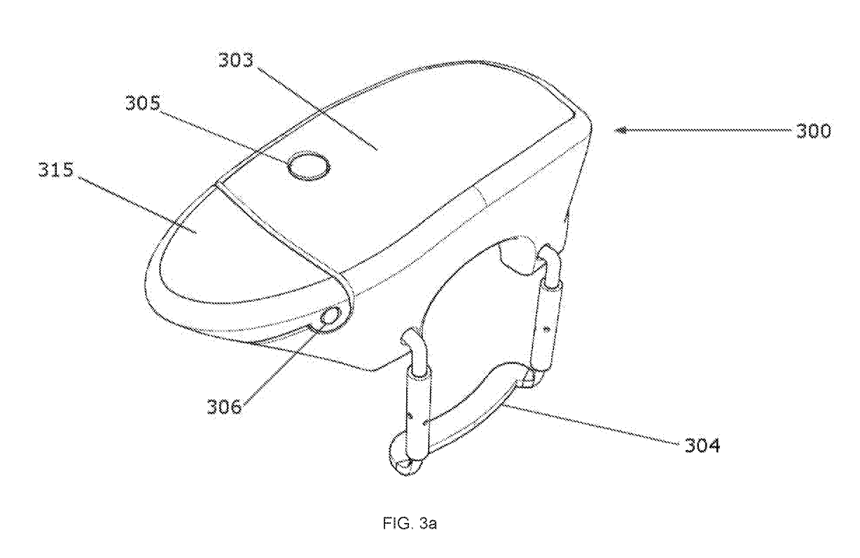

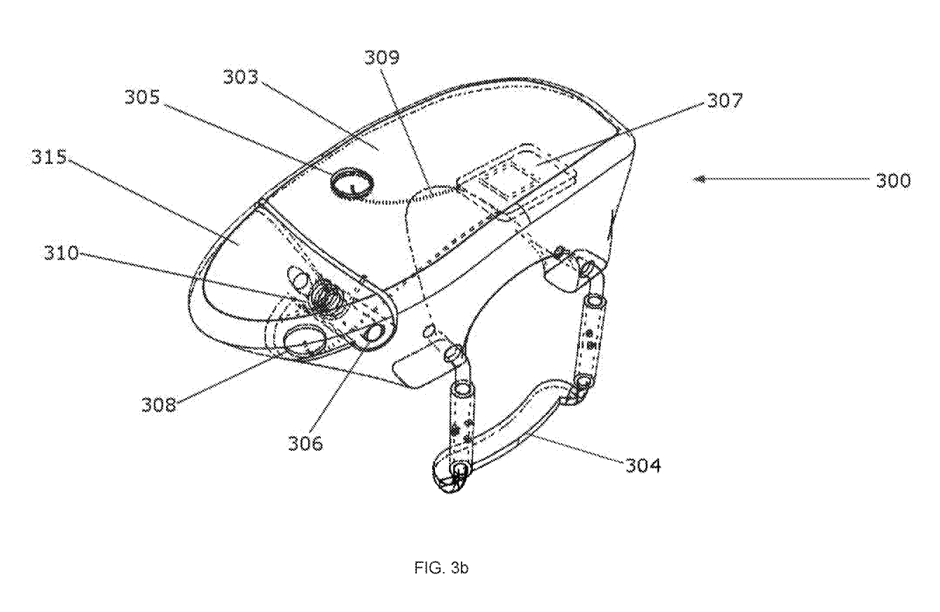

As shown in FIG. 2, the control mechanism may include a button 205. In the embodiments shown in FIGS. 3a and 3b, the control mechanism includes a touch sensitive sensor 305 together with a lever 315 having a pivot 306. As shown in FIGS. 3a and 3b, the lever 315 may be a portion of the contacting surface 303 that rotates about a pivot 306. In one embodiment, the lever 315 is a portion of the contacting surface 303 that can be actuated by pressing downwards like a button. In another embodiment, as shown in FIG. 4, the control mechanism 405 may form a portion or the entirety of the contacting surface 403 which rotates about a pivot 406. For example, the control mechanism may be the entire contacting surface 403 and can be actuated by pressing downwards like a button. In yet another embodiment, shown in FIG. 5, the control mechanism includes a vertical lever 505. The vertical lever 505 may include a slider mechanism 513 (discussed in more detail below) that enables a user to reposition the lever 505 with respect to the contacting surface 503. In other embodiments (not shown), the control mechanism may include a light sensitive sensor, a rotating knob, or a multi-directional joystick. The control mechanism can include other suitable components that may not require direct contact with the performer's head and can be, optionally, located behind (or underneath) the contacting surface, including but not limited to, a level sensor, an accelerometer, a heat-sensitive sensor, or a load cell sensor.

With reference to FIGS. 2 and 3b, the chinrest device 200, 300 includes a transceiver 207, 307 (e.g., a wireless device) (not shown in FIGS. 3a, 4 and 5) that receives and transmits control signals during operation of the chinrest device. The transceiver 207, 307 can be any suitable wired or wireless device, including but not limited to, a Wi-Fi device, a Bluetooth device, a WLAN device, WPAN device, a 3G device (e.g., a device that operates the third generation mobile communications standard) and 4G device (e.g., a device that operates the fourth generation mobile communications standard). During operation, the transceiver 207, 307 may be associated with a display device 602 to send and receive signals therebetween. As described in more detail below, in certain embodiments, the chinrest device 100, 200, 300, 400, 500 may optionally include a processor 720 and a memory 723.

Functional components either facilitate the function of the control mechanism, or facilitate detection of an actuation of a component of the control mechanism 205, 305, 306, 405, 406, 505. Functional elements include, but are not limited to, a chinrest device sensor 208, 308, 708 (not shown in FIGS. 3a, 4 and 5) to detect manipulation of the control mechanism 205, 305, 306, 405, 406, 505, wires 209, 309 to connect the chinrest device sensor 208, 308, 708 with the transceiver 207, 307 and/or a spring 210, 310 to return the movable component of the control mechanism 205, 305, 306, 405, 406, 505 to a neutral position after actuation.

According to embodiments described herein, the chinrest device has the capability to accommodate different body proportions, instrument positions, playing styles, or preferences of different users. In some embodiments, the control mechanism may have one or more adjustment features for adjusting the position of the control mechanism with respect to the contacting surface. Mechanical adjustment features may include, but are not limited to, adjustability of the position of the movable elements of the control mechanism, adjustability of the proportions of the movable elements, or adjustability of the activation threshold(s) of a control mechanism. The positioning of the chinrest device itself may be changed by adjusting the location and/or height of the attachment mechanism 204, 304, 404, 504. Non-mechanical adjustment features include, but are not limited to, reprogramming the transceiver to send a control signal at a different chinrest device sensor activation level, or reprogramming the transceiver to send a different control signal in response to a given actuation of a control mechanism. According to various embodiments, the control mechanism may include any suitable locking mechanism that allows the position of the control mechanism to be locked.

In some embodiments, the control mechanism 205, 305, 306, 405, 406, 505 may be mounted on an adjustment device for adjusting the position of the control mechanism. The adjustment device may be any suitable mechanism that enables the position of the control mechanism to be adjusted. In some embodiments, the adjustment device may be a slider mechanism 513 that includes a sliding element received within a slide element, for example, a rail, a pair of rails, a T-slot, or an undercut channel. The sliding element of the slider mechanism 513 can be moved relative to the contacting surface. The sliding element of the slider mechanism 513 may include a lock mounted on the sliding element, or on the slide element, to lock the sliding element in place. The lock may be a button, lever, knob, spring, any other suitable mechanism and combinations thereof. In some embodiments, the control mechanism 205, 305, 306, 405, 406, 505 and the lock are integrated into the same mechanism, such that the position of the sliding element of the slider mechanism 513 can be locked or unlocked by actuating the control mechanism in a different direction or manner than the actuation that activates the sensor 208, 308. For example if the control mechanism is a button 205, it could be mounted on a screw so that turning the button locks or unlocks the position of the sliding element of the slider mechanism 513. Or if the control mechanism is a lever 505, pressing the lever downwards could lock or unlock the control mechanism.

The chinrest device 100, 200, 300, 400, 500 may include a locking device for the control mechanism 205, 305, 306, 405, 406, 505 to disable actuation of the mechanism when desired and/or so that when the display action(s) are not desired, they do not occur. For example, if a performer must move from a seated position to the front of the stage, or if a user must move from one location to another, it is desirable to lock the control mechanism to prevent actuation until the performer or user is in position and places the display device in an appropriate location. According to various embodiments, the locking mechanism may be any suitable device that prevents actuation of the control mechanism. For example, the locking mechanism can include, but is not limited to, a button, lever, knob, spring, or any other mechanism or combination thereof, which can be engaged to prevent movement of the control mechanism. In embodiments, if a control mechanism 205, 305, 306, 405, 406, 505 is actuated by movement of the entire contacting surface 403, 405, or a portion of the contacting surface 315, then the chinrest device can optionally include a locking mechanism, which can be engaged to prevent movement of the control mechanism. The locking mechanism may depend on the control mechanism used, for example, if the control mechanism is the entire contacting surface 403, 405 (or a portion of the contacting surface 315) mounted on a pivot 306, 406, the pivot may include a threaded screw that can be tightened via a knob or lever that pulls the pivoting elements against each other and prevents any motion around the pivot. Alternatively, a button could push a locking pin into a recess on the control mechanism surface, preventing movement of the control mechanism. Or a button could push a wedge into the space that the control mechanism would otherwise move into when actuated, preventing movement of the control mechanism.

According to various embodiments, the control mechanism(s) may be removable and may include any suitable mechanism that allows the control mechanism to be removable. For example, the contacting surface 203, 303, 403, 503 may contain a hole, multiple holes, a slot in which pins or rails on the control mechanism can be inserted, or any other suitable mechanism that enables the control mechanism to be removable. Optionally, the contacting surface 203, 303, 403, 503 may include additional holes or slots or any other suitable mechanism so that the position of the control mechanism 205, 305, 306, 405, 406, 505 can be adjusted relative to the contacting surface by removing the control mechanism and inserting it into a different hole, slot, or set of holes.

In some embodiments, the functionality of the display actions can be disabled by removing the control mechanism, as described the preceding paragraph. The functionality may be disabled by a switch, button, or other suitable mechanism that breaks the connection between the sensor 208, 308 or the transceiver 207, 307 (or in embodiments which include a processor on the chinrest device, breaks the connection between the sensor and the processor or between the processor and the transceiver). The functionality can also be disabled by a button, lever, switch, or any other suitable mechanism which, when actuated, physically moves the sensor 208, 308 away (for example) from the position where it can be activated by actuation of the control mechanism.

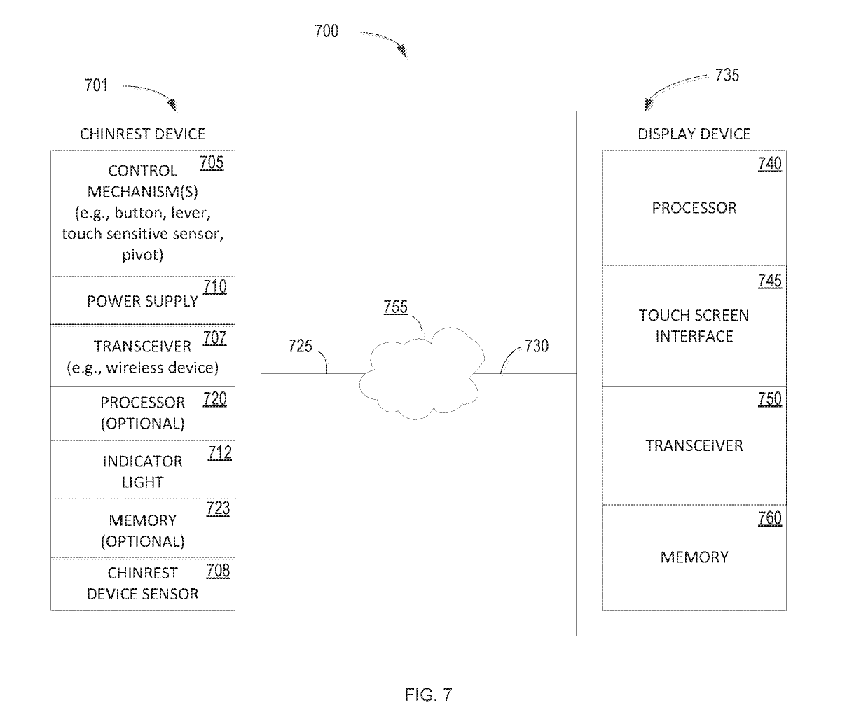

Referring again to FIG. 2, the chinrest device 200 may also include a connection port 211 into which a charging cable or communication cable can be connected, in order to program or monitor the behavior of the transceiver 207. A single cable that performs both communication and charging functions can also be used. The chinrest 200 may also include at least one indicator light 212 that can change in color, intensity, activation pattern, or a combination thereof depending on the state of the chinrest 201. As will be discussed in more detail with respect to FIG. 7, chinrest devices as described herein also include a power supply 710, such as a battery, to power the transceiver 207, 307, 707, the indicator light 212, 712 and the optional processor 720 (if installed). The power supply 710 may optionally be rechargeable and/or replaceable. In some embodiments, a chinrest device as described herein may include a removable panel to allow replacement of the battery. States that may be indicated by a change in an indicator light 212 can include, but are not limited to, low battery, full battery, successful connection to a display device, currently active connection to a display device, or no current connection to a display device. The indicator light 212 may also change to indicate the transmission of a control signal.

With reference to FIGS. 1-5, the chinrest device 100, 200, 300, 400, 500 may be portable and removably attachable to a stand or instrument by any suitable attachment mechanism 104, 204, 304, 404, 504. Generally, the chinrest device 100, 200, 300, 400, 500 can be removably attached to a ledge, shelf or any other suitable surface on which to use the chinrest device.

As shown in FIG. 6, a chinrest device as described herein may be associated with a display device 602. During use, the display device 602 performs a display action in response to an output signal received from the chinrest device 600. A display device 602 is defined as any device capable of receiving a signal from a chinrest device 602 and changing a display on a screen of the display device 602. Display devices include, but are not limited to, a tablet computer, a laptop computer, a desktop computer, an e-book reader, a television, a wireless projector, a smartphone, or a monitor.

A display action is any useful change in the state, display, or function of the display, for example, a digital musical score, a digital book, a text file, a spreadsheet, a digital presentation, a webpage a series of computer screens, etc., of the display device 602. As such, display actions encompass changes to how a document of musical notation is displayed, including but not limited to, a forward page turn, a backwards page turn, a forward or backwards scroll, a forward or backwards half page turn or other fractional page turn, a jump to the first or last page in the document, a jump to a different document, a jump to a custom position marker, a change in the size of the musical notation or some element of the musical notation, or a change in what portions of musical notation are displayed, for example, by showing or hiding a reference notation for musicians other than the performer. Display actions may also include changing at least one of a page of a musical notation, book or text file, spreadsheets, slides of a presentation, websites and computer screens. Display actions also encompass overall changes to the display of the display device 602, including but not limited to, an increase or decrease in the brightness of the display, an increase or decrease in the contrast of the display, a change in the color intensity of the display.

In some embodiments, display actions can also encompass functional actions that may not directly or immediately alter the display of a musical notation, including but not limited to, inserting a custom position marker, inserting a reference marker, or changing the associations of control signals to display action. Display actions also encompass the use of other capabilities of the display device 602, including but not limited to, beginning or terminating an audio recording, capturing a digital photograph, beginning or terminating a video recording, or opening or closing an application runnable by the display device 602. Display actions also encompass the activation of a specific function of an application runnable by the display device 602, including but not limited to, starting or stopping the pulse on a metronome application, changing the volume or tempo on a metronome application, activating a tuner on a tuner application, or changing the pitch evaluated by a tuner application.

An embodiment of a chinrest device system is shown in FIG. 7. The system includes a chinrest device 701 in communication with (i.e., via 725, 730) a display device 735 (e.g., a computing device). The chinrest device 701 can include at least one control mechanism 705, a power supply 710, a transceiver 707, an optional processor 720, an indicator light 712, an optional memory 732 and a chinrest device sensor 708. The system 700 further includes a display device 735. The display device 735 includes a display device processor 740, a screen 745 (e.g., a touch screen interface), a transceiver 750 and a memory 760.

During use, a user actuates the at least one control mechanism 705 of the chinrest device 701, which transmits at least one output signal 725 from the transceiver 707 to a display device 735 via a network 755. In one embodiment, different actuations of the control mechanism 705 can cause different control signals 725 to be transmitted. Parameters that can be used to discern different actuations of the control mechanism 705 include, but are not limited to, duration of actuation, speed of actuation, direction of actuation, forcefulness of actuation, pattern of actuation(s), and any combination thereof.

In some embodiments, multiple chinrest devices may be connected to a display device to simultaneously control the display on the display device, or to control different elements (e.g., two different music scores) of the display on the display device. This could be useful for stand partners in orchestra who generally share the same display. In certain embodiments, a chinrest device can control the display, or certain elements of the display, of multiple display devices. This could be useful for large string sections in orchestra who are generally all looking at similar copies of the same display.

Also described herein are methods for changing the display of at least one display device 735 using at least one chinrest device 701 as described herein. During operation, the control mechanism 705 may be actuated, for example, by pushing a button, moving a lever or moving a contact surface, with a user's head. The actuation may include moving the control mechanism 705 from a first position to a second position. For example, the control mechanism 705 may pivot in a lateral motion or in a vertical motion from one position to another. Such actuation sends an input signal to the chinrest device sensor 708, thereby activating the sensor 708. The sensor 708 can transmit an activation signal to the transceiver 707 directly, or via the optional device processor 720 (if installed). If the processor 720 is installed on the chinrest device 701, the processor 720 may load an active control device behavior protocol from an optional memory 723 of the chinrest device 701. The processor 720 then determines the appropriate activation signal to transmit to the transceiver 707. The transceiver 707 transmits an output signal 725 (e.g., broadcasts a wireless signal), which is received 730 by the display device transceiver 750. A processor 740 of the display device 735 determines an appropriate display action based on the signal received 730. When determining the appropriate display action, the processor 740 of the display device 735 may access data (e.g., stored in a file, a chinrest device driver application, a chinrest device image viewer application, a digital musical score, etc.) from a memory 760 on the display device. The processor 740 then loads the determined display on the display device memory 760, which is then displayed on a screen 745 of the display device 735.

In certain embodiments, it may be possible to set a behavior protocol of the control device 705. For example, an interface application may be loaded onto a display device 735 and accessible to a user. An operating mechanism (e.g., a keyboard or a mouse) (not shown) associated (e.g., hard-wired or wirelessly connected) with the display device 735 may receive an input, which is transmitted to the interface application stored in the memory 760. The interface application will then interpret the input signal and correspondingly set desired elements of the behavior protocol (e.g., sensitivity of the control mechanism to touch or movement). The display device transceiver 750 then broadcasts a signal indicative of the protocol. The chinrest device transceiver 707 can detect the protocol signal and the control device processor 720 can interpret the protocol signal. The chinrest device transceiver 707 may then save the appropriate protocol onto the chinrest device memory 723.

In another embodiment, an alternate system with similar functionality may be used where the interface application runs on the chinrest device (e.g., on the control device) 701 itself. The control device may establish connections (e.g., hard-wired or wireless) 725, 730 with the display device 735 to display the graphic user interface (GUI) of the interface application, and the keyboard/mouse (not shown) associated with the display device 735 will receive an input to set the protocol as described above. An interface application with a GUI is an optional feature. Changes to the protocol could also be indicated by activation, intensity, or pattern of the indicator light(s) 712 on the chinrest device 701. Alternatively, changes to the protocol do not necessarily have to be indicated at all (other than by the subsequent behavior of the control device). In another embodiment, an alternate system with similar functionality can be used wherein the chinrest device 701 includes input keys (or other input mechanisms) in addition to the main control mechanism(s) 705, and specific input, sequences of input, and durations of input can be used to set the protocol instead of a keyboard/mouse.

In some embodiments, the control mechanism(s) 705 may be actuated to transmit an input signal to the sensor 708 thereby activating the sensor 708. The sensor 708 then sends an activation signal to the chinrest device transceiver 707. The transceiver 707 sends (e.g., broadcasts a wireless signal) an output signal 725. The transceiver 750 on the display device 735 receives the signal 730 and the processor 740 loads a behavior protocol from the display device memory 760. The processor 740 determines an appropriate display action and loads a new display a file stored in the display device memory 760. The determined display is then displayed on a screen 745 of the display device 735.

To set the control device behavior protocol, the display device 735 may load and display the interface application. An operating mechanism (e.g., a keyboard or mouse) (not shown) associated with the display device 735 receives an input and transmits the input to the interface application. The interface application then interprets the input and sets the elements of the behavior protocol. The protocol is then saved to the display device memory 760.

In some embodiments, control mechanism 705 and display device 735 are not connected directly to each other, but instead each component connects to a wireless access point (e.g., a modem) and communicates over the modem's wireless network 755. During operation, the control mechanism 705 is actuated. The control mechanism 705 sends an input signal to the sensor 708, which is then activated. Then sensor 708 then sends an activation signal to transceiver 707, thereby activating the transceiver 707. The transceiver 707 sends (e.g., broadcasts a wireless signal) an output signal 725, which is received by the modem. The modem then sends a signal (e.g., broadcasts a wireless signal) to the transceiver 750 on the display device 735. A processor 740 on the display device 735 determines an appropriate display action and loads the new display from a file stored on the display device memory 760. The determined display is then displayed on a screen of the display device 735. In some embodiments, the display device 735 and the chinrest device 701 may be connected to different modems, which communicate with each over the Internet or a local network.

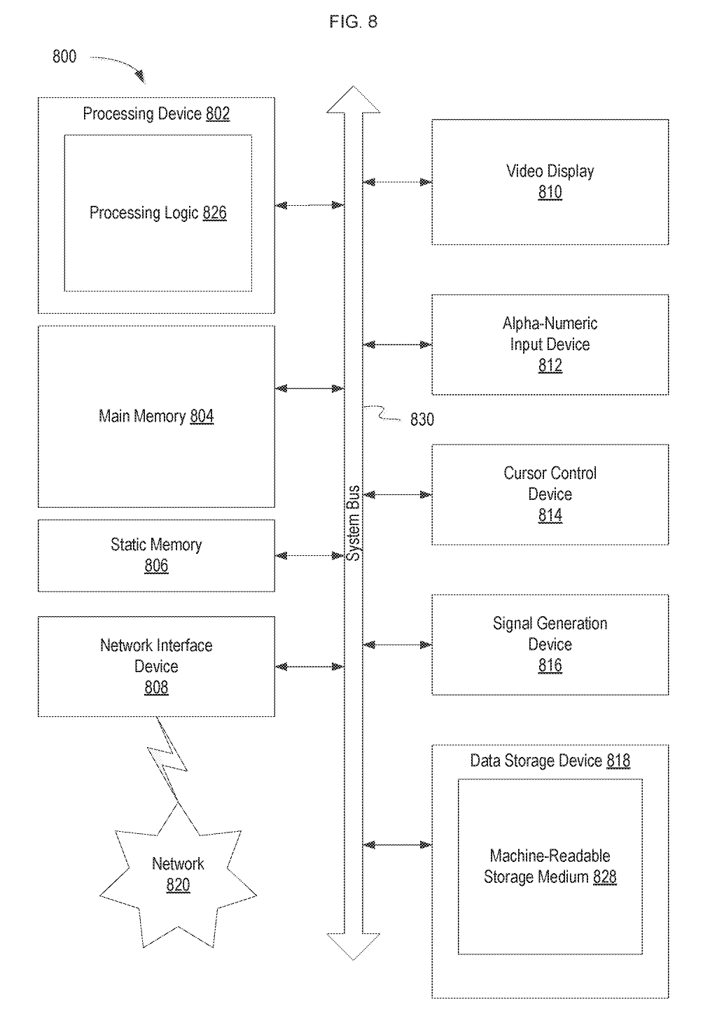

FIG. 8 illustrates a diagrammatic representation of a machine in the example form of a computer system 800 (e.g., a display device) including a set of instructions executable by a chinrest device system to perform any one or more of the methodologies discussed herein. In one embodiment, the system may include instructions to enable execution of the processes and corresponding components shown and described in connection with FIGS. 1-7.

In alternative embodiments, the chinrest device system may include a machine connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies described herein.

The example computer system 800 includes a processing device (processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 818, which communicate with each other via a bus 830.

Processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. In various embodiments of the present disclosure, the processing device 802 is configured to execute instructions for the chinrest device system for performing the operations and processes described herein.

The computer system 800 may further include a network interface device 808. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 816 (e.g., a speaker).

The data storage device 818 may include a computer-readable medium 828 on which is stored one or more sets of instructions of the chinrest device system embodying any one or more of the methodologies or functions described herein. The instructions may also reside, completely or at least partially, within the main memory 804 and/or within processing logic 826 of the processing device 802 during execution thereof by the computer system 800, the main memory 804 and the processing device 802 also constituting computer-readable media.

The instructions may further be transmitted or received over a network 820 via the network interface device 808. While the computer-readable storage medium 828 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely presented as examples. Particular implementations may vary from these example details and still be contemplated to be within the scope of the present disclosure. In the above description, numerous details are set forth.

It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “rating,” “selecting,” “comparing,” “adjusting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description.

I/We claim:

1. A chinrest device, comprising:
a contacting surface comprising a contour for receiving at least one of a neck, jaw, chin or head;
at least one control mechanism;
at least one sensor in communication with the at least one control mechanism; and
a transceiver in communication with the at least one sensor.

2. The device of claim 1, wherein the chinrest device further comprises an attachment mechanism.

3. The device of claim 2, wherein the attachment mechanism is adapted to attach the chinrest device to a violin, a viola or a chinrest device stand.

4. The device of claim 1, wherein the control mechanism comprises an adjustment device for adjusting the position of the control mechanism on the contacting surface.

5. The device of claim 1, further comprising an indicator light.

6. The device of claim 1, further comprising a processor, wherein the processor is in communication with the at least one sensor and the transceiver.

7. The device of claim 6, further comprising a battery to power at least one of the transceiver, the at least one sensor or the processor.

8. The device of claim 1, wherein the contacting surface comprises a material selected from a group consisting of leather, plastic, nylon composite, polylactic acid, acrylonitrile butadiene styrene, plastic composite, ceramic, fiberglass, epoxy, metal, carbon-fiber, fiber-glass, wood, foam, cotton and combinations thereof.

9. The device of claim 1, wherein the control mechanism is selected from a group consisting of a button, a touch sensitive sensor, a vertical lever, a light sensitive sensor, a rotating knob, a multi-directional joystick, a pivot, a level sensor, an accelerometer, a heat-sensitive sensor, a load cell sensor, a spring and combinations thereof.

10. The device of claim 1, wherein the transceiver is a wireless communications device selected from a group consisting of a Wi-Fi device, Bluetooth device, WLAN device, WPAN device and 4G device.

11. A system for controlling a display of at least one display device, comprising:
a chinrest device; and
at least one display device comprising:
a memory;
a wireless transceiver;
a display; and
a processor operatively coupled to the memory, the wireless transceiver and the display, wherein the processor is configured to:
receive a chinrest device output signal from a chinrest device via the wireless transceiver;
determine a display action based on the chinrest device output signal;
access data on which the display action is to be performed from the memory; and
perform the display action on the data.

12. The system of claim 11, wherein the display action is selected from a group consisting of a forward or backward page turn, a forward or backward scroll, a forward or backward half page turn, a fractional page turn, a jump to the first or last page in a document, a jump to a different document, a jump to a custom position marker, a change in size of a musical notation, a change in an element of a musical notation, or a change in a portion of musical notation and showing or hiding a reference notation for musicians other than a performer.

13. The system of claim 11, wherein the chinrest device comprises a control mechanism, and wherein different control signals are transmitted depending on the manner of actuation of the control mechanism.

14. A computer-implemented method of changing a display on a display device using a chinrest device, comprising:
receiving by a sensor of a chinrest device, an input signal from a control mechanism of the chinrest device;
generating a chinrest device output signal by the chinrest device sensor;
transmitting, by the chinrest device, the chinrest device output signal to a display device, wherein a processor of the display device determines a display action based on the chinrest device output signal and accesses data on which the display action is to be performed from a memory of the display device; and
performing a display action by the display device, wherein performing the display action comprises displaying at least a portion of the data on a user interface of the display device.

15. The method of claim 14, wherein the display device is selected from a group consisting of a tablet computer, a laptop computer, a desktop computer, an e-book reader, a television, a wireless projector, a smartphone and a monitor.

16. The method of claim 14, wherein the control mechanism is selected from a group consisting of a button, a touch sensitive sensor, a vertical lever, a light sensitive sensor, a rotating knob, a multi-directional joystick, a pivot, a level sensor, an accelerometer, a heat-sensitive sensor, a load cell sensor, a spring and combinations thereof.

17. The method of claim 14, wherein the input signal from the control mechanism results from actuation of the control mechanism.

18. The method of claim 17, wherein actuation of the control mechanism comprises moving the control mechanism from a first position to a second position.

19. The method of claim 17, wherein actuation of the control mechanism comprises pivoting the control mechanism in a lateral motion or moving the control mechanism in a vertical motion.

20. The method of claim 14, wherein the display is selected from a group consisting of a digital musical score, a digital book, a text file, a spreadsheet, a digital presentation, a webpage and series of computer screens.

21. The method of claim 15, wherein the data comprises a musical score, and wherein performing the display action comprises changing a page of the musical score.

22. The method of claim 14, wherein the input signal from the control mechanism results from actuation of a button, a touch sensitive sensor, a vertical lever, a light sensitive sensor, a rotating knob, a multi-directional joystick, a pivot, a level sensor, an accelerometer, a heat-sensitive sensor, a load cell sensor and combinations thereof.

23. The method of claim 14, wherein the data is selected from a group consisting of a chinrest device driver application, a chinrest device image viewer application and a digital musical score file.

24. The method of claim 14, wherein the chinrest device is attached to a violin, a viola or a chinrest device stand.
